(19) United States
(12) Patent Application Publication
(10) Pub. No.: US 2009/0116240 A1
(43) Pub. Date: May 7, 2009

(54) LED HEAT DISSPATION MODULE

(75) Inventor: Ching Ho, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA Precision Inc., Taipei (TW)

(21) Appl. No.: 12/260,093

(22) Filed: Oct. 29, 2008

(30) Foreign Application Priority Data
Nov. 7, 2007 (TW) 96142055

(51) Int. Cl. F21V 29/00

(52) U.S. Cl. 362/253

(57) ABSTRACT

An LED heat dissipation module including a heat pipe, an LED and a heat sink is provided. The heat pipe has at least a flat portion having a surface. The LED is provided at the surface of the flat portion of the heat pipe. The heat sink is coupled to the heat pipe. The heat dissipation efficiency of the LED heat dissipation module is increased.

### CROSS-REFERENCE TO RELATED APPLICATION

This application claims the priority benefit of Taiwan application serial no. 96142055, filed on Nov. 7, 2007. The entirety of the above-mentioned patent application is hereby incorporated by reference herein and made a part of this specification.

### BACKGROUND OF THE INVENTION

1. Field of the Invention

The invention relates to a heat dissipation module and, more particularly, to a light emitting diode (LED) heat dissipation module.

2. Description of the Related Art

An LED is a semiconductor element and is mainly made of the III-V compound semiconductor material having a characteristic of converting the electric energy to the light energy. In detail, when a current is applied to the semiconductor material, the electrons in the semiconductor material are recombined with the electron holes, and the energy is released in the form of lightn.

The light emitting phenomenon of the LED usually is regarded as cold illuminating instead of thermoluminescence or discharge illuminating. Therefore, the lifespan of the LED device may be more than one hundred thousand hours, and the LED device has no idling time. In addition, the LED device has advantages of rapid respond speed (approximate 10⁻⁹ seconds), small size, low power consumption, little pollution (without mercury) and high reliability, and it is suitable to be in mass production. Thus, the LED device is used widely.

### BRIEF SUMMARY OF THE INVENTION

One objective of the invention is to provide a LED heat dissipation module with a long lifespan.

To obtain the above or other objectives, a embodiment of the invention provides an LED heat dissipation module including a heat pipe, an LED and a heat sink. The heat pipe has at least a flat portion which has a surface. The LED is disposed at the surface of the flat portion of the heat pipe. The heat sink is coupled to the heat pipe.

In one embodiment of the invention, the LED further includes a substrate fixed at one end of the heat pipe.

In one embodiment of the invention, the substrate is made of aluminum.

In one embodiment of the invention, the heat sink is an aluminum extruded heat sink.

In one embodiment of the invention, the heat sink is made of aluminum or copper.

In one embodiment of the invention, the LED heat dissipation module further includes a fastener, and at least one of the LED and the heat sink is fixed at the heat pipe via the fastener.

In one embodiment of the invention, the LED heat dissipation module further includes a plurality of locking elements, and at least one of the LED and heat sink is fixed at the heat pipe via the locking elements.

In one embodiment of the invention, the locking elements are screws.

In one embodiment of the invention, the LED heat dissipation module includes an adhesive layer which is provided between the LED and the heat pipe or between the heat sink and the heat pipe.

In one embodiment of the invention, the adhesive layer is made of thermosetting adhesive or tin paste.

In the LED heat dissipation module of the invention, the shape of the heat pipe is improved to be flat, and therefore, the LED is provided on the surface of the flat portion of the heat pipe successfully, and the heat sink is coupled to the heat pipe. In this way, the heat generated from the LED is dissipated by the heat pipe and the heat sink. Therefore, the LED heat dissipation module achieves good heat dissipation effect, and has long lifespan.

These and other features, aspects, and advantages of the present invention will become better understood with regard to the following description, appended claims, and accompanying drawings.

### BRIEF DESCRIPTION OF THE DRAWINGS

FIG. 1 is a top view showing a LED heat dissipation module of one embodiment of the invention.

FIG. 2 is a lateral view showing the LED heat dissipation module in FIG. 1.

### DETAILED DESCRIPTION OF THE EMBODIMENTS

For a long time, there is a deep-seated technology bias that the LED does not need heat sink to dissipate the heat for the power consumption of the LED is low. However, when the LED converts the electric energy to the light energy, heat is still generated, which causes the temperature of the environment around the LED to increase. If the environmental temperature of the LED continuously increases, the decline speed of the LED become fast, which may affect the lifespan of the LED. In addition, if the environmental temperature of the LED continuously increases, the light wavelength of the LED is easily to be deviated, which affects the optical effect of the LED.

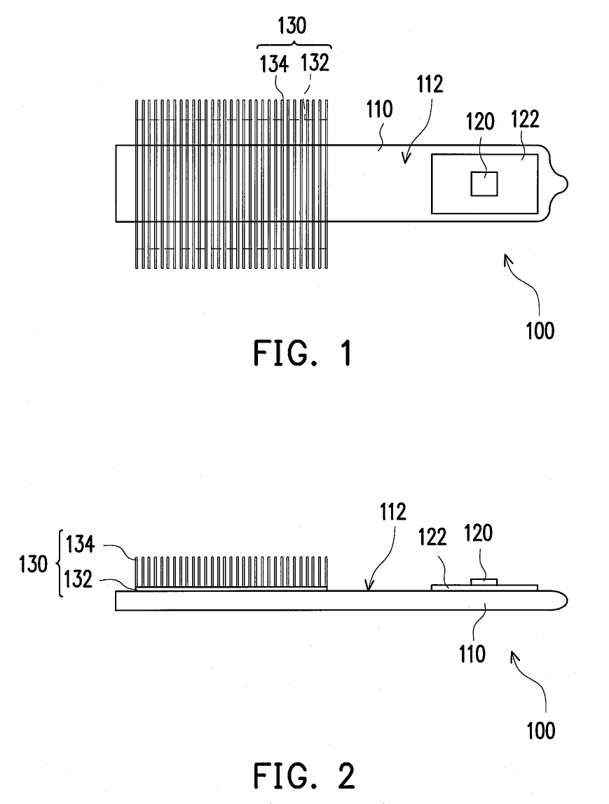

FIG. 1 is a top view showing an LED heat dissipation module of one embodiment of the invention. FIG. 2 is a lateral view showing the LED heat dissipation module in FIG. 1. As shown in FIG. 1 and FIG. 2, the LED heat dissipation module 100 includes a heat pipe 110, an LED 120 and a heat sink 130.

The heat pipe 110 has a flat portion which has a surface 112. Since the heat pipe 110 has a special shape, the LED 120 may be disposed at the surface 112 of the flat portion of the heat pipe 110, and the LED 120 is provided at one end of the heat pipe 110. The LED 120 is a semiconductor element which is mainly made of III-V compound semiconductor material. When the LED 120 converts the electric power to the light power, heat is released. Since the LED 120 is the heat source, the end where the LED 120 is provided at the heat pipe 110 is the hot end. In addition, if the single LED 120 is directly provided on the heat pipe 110, the over great thermal resistance causes the heat dissipation effect of the LED 120 to be bad. Therefore, the LED 120 may be disposed on a substrate 122 made of metal with a good heat conductivity such as aluminum first.

The heat sink 130 is coupled to the heat pipe 110. Compared with the hot end where the LED 120 is provided, the end where the heat sink 130 is provided is the cold end. The heat sink 130 includes a base 132 and a fin assembly 134, and it may be an aluminum extruded heat sink. The base 132 and the fin assembly 134 may be integrally formed. In addition, the fin assembly 134 may be assembled at the base 132 in the mode of the tight fit, fastening, locking and so on. To allow the LED heat dissipation module 100 to have a good heat dissipation effect, the material of the heat sink 130 is metal which is easy to conduct the heat such as aluminum or copper.

To allow at least one of the LED 120 and the heat sink 130 to be steadily disposed on the heat pipe 110, the LED heat dissipation module 100 further includes a fastener (not shown), and at least one of the LED 120 and the heat sink 130 is fixed on the heat pipe 110 via the fastener. In addition, at least one of the LED 120 and the heat sink 130 may be fixed on the heat pipe 110 via the adhesive layer or locking elements. The adhesive layer includes the thermosetting adhesive or tin paste, and the locking elements may be screws. People having ordinary skills in the art may easily know and think of the method of disposing the LED 120 and the heat sink 130 at the two ends of the heat pipe 110 according to the specification or other public paper. Therefore, it is not described any more.

When the current is applied to the LED 120, the electrons in the LED 120 are combined with the electron holes, the surplus energy is released as light, and the heat is released. At that moment, the heat of the LED 120 may be conducted to the heat pipe 110 quickly via the substrate 122, and the liquid at the hot end of the heat pipe 110 sublimates to gas after heated. The gas is light, and it rises. The change of the pressure allows the liquid at the cold end to flow to fill the room that the gas leaves with the liquid. The flowing gas and liquid cause a convection phenomenon in the heat pipe 110.

The cold end of the heat pipe 110 is provided with the heat sink 130. Therefore, when the hot air is convected to the cold end of the heat pipe 110, the heat is quickly conducted to heat sink 130 and is dissipated to the cold air via the heat sink 130. In addition, the air whose heat is taken away condenses to be liquid and flows to the hot end of the heat pipe 110 again. In the LED heat dissipation module 100, by circulating the heat dissipation steps, the heat is quickly dissipated to the cold environment.

People having ordinary skills in the art may know the working principle of the heat pipe 110 via the public paper, and therefore, it is described without drawings herein.

From the above, in the LED heat dissipation module 100, the heat of the LED 120 is quickly conducted to the heat pipe 110 via the substrate 122. Then, via the heat convection, the heat is quickly conducted to the cold end from the hot end of the heat pipe 110. At last, the heat sink 130 is used to dissipate the heat conducted to the cold end to the cold environment. Compared with the conventional technology, in the LED heat dissipation module 100, the heat is dissipated via the heat pipe 110 cooperated with the heat sink 130. Thus, the heat dissipation effect of the LED heat dissipation module 100 is improved.

When the LED heat dissipation module 100 may dissipate the heat effectively, the LED 120 may keep good optical effect, the lifespan of the LED 120 is prolonged.

Since the shape 110 of the heat pipe 110 is easy to be designed according to the actual need. For example, the shape may be designed to be strip-shaped, horse hoof-shaped or other shape. The length of the heat pipe 110 also may be lengthened or shortened according to the usage need. In this way, the position of the heat sink 130 may be determined first, and the shape and length of the heat pipe 110 may be chosen according to the usage need. The LED heat dissipation module 100 has the elasticity in position disposition, and the room waste is avoided.

To sum up, the LED heat dissipation module at least has the following advantages.

First, at least one end of the heat pipe is improved to be flat to allow the LED to be directly and flat attached to the heat pipe, which overcomes the deep-seated technology bias.

Second, via the heat pipe and the heat sink, the LED heat dissipation module may dissipate heat effectively, and therefore, the LED may have a good optical effect, and the usage lifespan is prolonged.

Third, the shape and length of the heat pipe may be designed according to the need, and therefore, the LED heat dissipation module has the elasticity in position disposition, and the room waste is avoided.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A light emitting diode (LED) heat dissipation module comprising:
a heat pipe having a flat portion which has a surface;
an LED disposed on the surface; and
a heat sink coupled to the heat pipe.

2. The LED heat dissipation module according to claim 1, wherein the LED further comprises a substrate fixed at the surface.

3. The LED heat dissipation module according to claim 2, wherein the base is made of aluminum.

4. The LED heat dissipation module according to claim 1, wherein the heat sink is an aluminum extruded heat sink.

5. The LED heat dissipation module according to claim 4, wherein the heat sink is made of aluminum or copper.

6. The LED heat dissipation module according to claim 1, further comprising a fastener, wherein at least one of the LED and the heat sink is fixed at the heat pipe via the fastener.

7. The LED heat dissipation module according to claim 1, further comprising a plurality of locking elements, wherein at least one of the LED and the heat sink is fixed at the heat pipe via the locking elements.

8. The LED heat dissipation module according to claim 7, wherein the locking elements are screws.

9. The LED heat dissipation module according to claim 1, further comprising an adhesive layer provided between the LED and the heat pipe or between the heat sink and the heat pipe.

10. The LED heat dissipation module according to claim 9, wherein the material of the adhesive layer comprises the thermosetting adhesive or tin paste.
